(19) United States
(12) Patent Application Publication
(10) Pub. No.: US 2015/0330617 A1
(43) Pub. Date: Nov. 19, 2015

(54) LED MODULE

(71) Applicant: OSRAM GmbH, Muenchen (DE)

(72) Inventors: Guenter Hoetzl, Regensburg (DE); Tobias Staeber, Regensburg (DE)

(21) Appl. No.: 14/394,103

(22) PCT Filed: Apr. 17, 2013
(86) PCT No.: PCT/EP2013/057984

§ 371 Date: Oct. 13, 2014

(30) Foreign Application Priority Data
Apr. 19, 2012 (DE) 102012206447.8

(51) Int. Cl. F21V 29/51; F21V 23/00; F21K 99/00

(52) U.S. Cl. CPC F21V 29/51; F21K 9/30; F21V 23/006; F21Y 2101/02

(57) ABSTRACT

An LED module may include at least one LED, at least one first printed circuit board, on which the at least one LED is arranged, and a support element which is designed to support the at least one first printed circuit board. The support element is embodied as a heat pipe arrangement which includes at least one heat pipe.

### RELATED APPLICATIONS

The present application is a national stage entry according to 35 U.S.C. §371 of PCT application No.: PCT/EP2013/057984 filed on Apr. 17, 2013, which claims priority from German application No.: 10 2012 206 447.8 filed on Apr. 19, 2012, and is incorporated herein by reference in its entirety.

### TECHNICAL FIELD

Various embodiments generally relate to an LED module.

### BACKGROUND

LED modules which have a printed circuit board on which the LEDs are arranged and one or more further printed circuit boards on which the driver electronics system for the LEDs is arranged are known from the prior art. These printed circuit boards are arranged in a housing which serves as a mount for the printed circuit boards. Here, the housing is fabricated from a material with a high level of thermal conductivity, for example aluminum, with the result that the housing can serve simultaneously for conducting away heat. Furthermore, the housing is electrically insulated toward the outside, for example by a further plastic housing.

It is disadvantageous in such modules that they are relatively large since despite the aluminum housing conducting heat away a certain amount of free space has to be left in the housing for sufficient dissipation of heat.

### SUMMARY

Various embodiments provide an LED module which is configured in a more compact and space-saving way.

The LED module according to various embodiments includes at least one LED, at least one first printed circuit board, on which the at least one LED is arranged, and a support element which is designed to support the at least one first printed circuit board. Furthermore, the support element is embodied as a heat pipe arrangement which includes at least one heat pipe.

The support element may therefore simultaneously perform the function of conducting away heat. In contrast to the related art, the use of heat pipes permits, on the one hand, much more efficient conduction away of heat, since heat pipes are much better thermal conductors than, for example, an aluminum housing and, on the other hand, a much high level of flexibility in terms of the arrangement possibilities of the heat pipe and the other components of the LED module is provided than when a solid aluminum housing is used. As a result, an LED module according to the present disclosure may be configured in a much more space-saving fashion. A further advantage is that as a result of the various arrangement possibilities the heat pipe arrangement may be arranged directly at the locations at which most heat is generated. This also increases the efficiency of the conduction away of heat, as a result of which it is moreover also possible to configure the LED module according to the present disclosure more compactly without the risk of excessive heating as a result of the compact arrangement of the components.

In various embodiments, the LED module includes a housing which is formed from an electrically insulating material and which is embodied at least partially as a boundary of the LED module toward the outside. Since the supporting and heat-dissipating function is performed by the heat pipe arrangement, an electrically insulating element, for example a plastic housing, is sufficient as the housing, and there is no longer any need for a thick solid aluminum housing, as a result of which the size of the LED module is also reduced.

Furthermore, the LED module may include a base element, wherein the at least one heat pipe is arranged in a thermally contact-forming fashion with one end on the at least one first printed circuit board, and with another end on the base element of the LED module. In particular, the base element represents a boundary of the LED module toward the bottom, i.e. toward the side lying opposite the first printed circuit board. The best possible transportation of heat away to the outside is ensured by the thermal connection with the first printed circuit board to the base element through the at least one heat pipe.

In various embodiments, the LED module includes at least one second printed circuit board and one driver electronics system arranged on the at least one second printed circuit board for the at least one LED. In this context, the at least one second printed circuit board is arranged between the at least one first printed circuit board and the base element of the LED module. Furthermore, by means of the heat pipe there is a thermal connection between the at least one second printed circuit board and the base element, and a thermal connection between the at least one second printed circuit board and the one first printed circuit board. As a result, a driver electronics system for the at least one LED may be integrated into the LED module, wherein the heat pipe arrangement also simultaneously ensures cooling of the second printed circuit board and of the driver electronics system. In addition, the at least one heat pipe may be used as a guide for electrical connections between the printed circuit boards.

The heat pipe arrangement may advantageously include a base element and a cover element which are embodied in one piece with the at least one heat pipe, and wherein the at least one first printed circuit board is arranged on the cover element. This spatially extended structure of the heat pipe arrangement additionally increases the efficiency during the conduction away of heat, in particular from the first printed circuit board to the base element.

Furthermore, the base element of the heat pipe arrangement may be the base element of the LED module or may be arranged thereon in a thermally contact-forming fashion. The base element of the LED module may therefore be embodied, for example, as an aluminum plate or as a planar mount for the base element of the heat pipe arrangement. The base element as a boundary of the LED module may also optionally be formed by the heat pipe arrangement itself. In both cases, good conduction away of heat toward the outside is ensured.

In various embodiments, the base element of the heat pipe arrangement and/or the cover element are embodied at least partially as planar heat pipes.

In various embodiments, the base element of the heat pipe arrangement and/or the cover element are embodied at least partially as spiral-shaped heat pipes.

Furthermore, these embodiment variants of base element and cover element may also be combined with one another.

Furthermore, the LED module may include a connecting element via which at least one electronic component of the driver electronics system is thermally coupled to the heat pipe arrangement, in particular to the base element thereof. In this way, an even better thermal connection of the driver electronics system to the heat pipe arrangement may be brought about, which permits even better cooling of the driver electronics system.

In various embodiments, the heat pipe arrangement is embodied as a housing of the LED module, wherein the housing has at least one opening, wherein the first printed circuit board is arranged on the at least one opening on the housing in a thermally contact-forming fashion, wherein the at least one second printed circuit board is arranged in the housing, and wherein the housing is encased by an electrically insulating material. In this way, the heat pipe arrangement can, for example, be integrated directly into an electrically insulating plastic housing, which also permits a very space-saving configuration of the LED module.

Furthermore, the heat pipe arrangement may be embodied as a support of the housing of the LED module. In general, the housing of the LED module may have attachment elements by means of which the housing may be attached to the heat pipe arrangement. In particular, by means of this attachment it is possible to make available the functionality of the heat pipe arrangement as a support for the electrically insulating housing.

Furthermore, the heat pipe arrangement may be embodied as a spatially extended structure, in particular as a hollow cylinder and/or in the form of a right parallelepiped. In one embodiment the heat pipe is preferably embodied in a beaker shape, i.e. as a hollow cylinder with a base, as the housing of the LED module or as the support of the electrically insulating housing. The extended structure of the heat pipe arrangement can, however, also be embodied with a different shape, preferably adapted to the shape of the LED module. In particular, an individual heat pipe may also be embodied as a spatially extended structure.

In various embodiments, the base element of the heat pipe arrangement includes base mount elements which are designed to attach the LED module to a base mount system. The LED module may preferably be attached with the base mount elements by latching these elements into a base mount system. The heat pipe arrangement may therefore also simultaneously serve as an attachment device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic illustration of an LED module with a heat pipe according to an embodiment of the present disclosure;

FIG. 2A shows a schematic illustration of an LED module with a heat pipe arrangement with a centrally arranged heat pipe and a base element and cover element according to an embodiment of the present disclosure;

FIG. 2B shows a schematic illustration of a plan view of a base element and/or cover element with spiral-shaped heat pipes of a heat pipe arrangement of an LED module according to an embodiment of the present disclosure;

FIG. 3A shows a schematic illustration of an LED module with a heat pipe arrangement with a laterally arranged heat pipe and a base element and cover element according to an embodiment of the present disclosure;

FIG. 3B shows a schematic illustration of a plan view of a base element and/or cover element with planar heat pipes of a heat pipe arrangement of an LED module according to an embodiment of the present disclosure;

FIG. 4A shows a schematic illustration of an LED module with a heat pipe arrangement and connecting elements for thermally connecting the driver electronics system according to an embodiment of the present disclosure;

FIG. 4B shows a schematic illustration of a plan view of a heat pipe arrangement with planar heat pipes as a base element and cover element of an LED module according to an embodiment of the present disclosure;

FIG. 5 shows a schematic illustration of an LED module with a heat pipe arrangement integrated in the insulation housing, according to an embodiment of the present disclosure;

FIG. 6 shows a schematic illustration of an LED module with a heat pipe arrangement, a metallic base element and laterally extending heat pipes with base mount elements according to an embodiment of the present disclosure;

FIG. 7 shows a schematic illustration of an LED module with a heat pipe arrangement with laterally extending heat pipes and a housing with attachment elements according to an embodiment of the present disclosure;

FIG. 8A shows a schematic illustration of a plan view of a heat pipe arrangement and a housing which is attached to the heat pipe arrangement by means of attachment elements, according to an embodiment of the present disclosure; and

FIG. 8B shows a further schematic illustration of a plan view of a heat pipe arrangement and a housing which is attached to the heat pipe arrangement by means of attachment elements, according to an embodiment of the present disclosure.

### DETAILED DESCRIPTION

The following detailed description refers to the accompanying drawing that show, by way of illustration, specific details and embodiments in which the disclosure may be practiced.

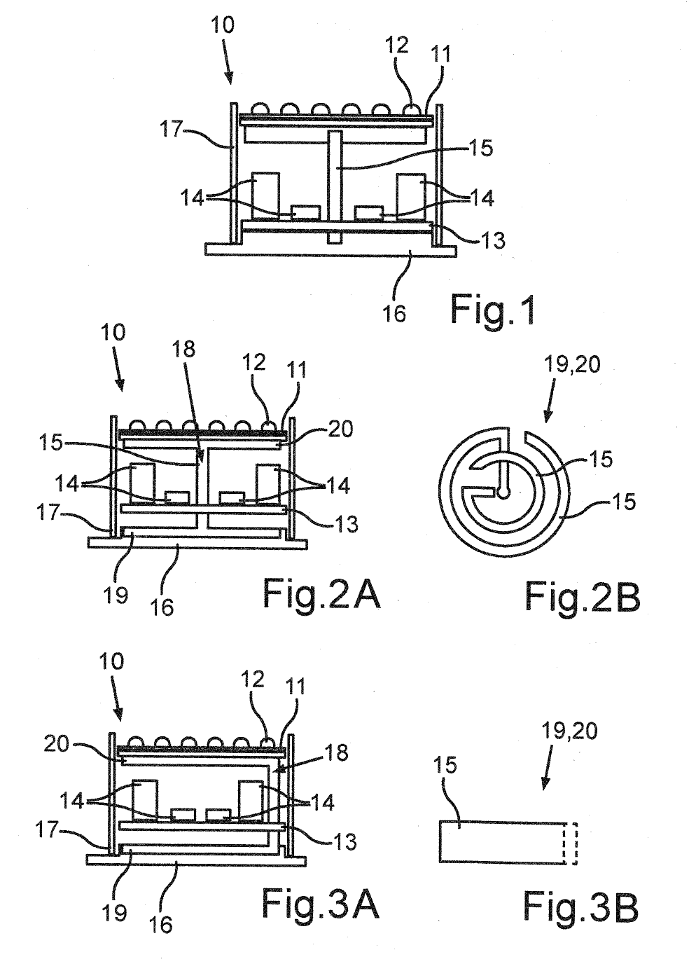

FIG. 1 shows a schematic illustration of an LED module 10 with a heat pipe 15 according to an embodiment of the present disclosure. The LED module 10 includes here a first printed circuit board 11 on which LEDs 12 are arranged, and a second printed circuit board 13 on which the driver electronics system 14 for the LEDs 12 is arranged. Furthermore, the LED module 10 is bounded toward the sides by an insulation housing 17 made of an electrically insulating material, for example plastic. Toward the bottom, the LED module 10 is bounded by an aluminum base element 16. A heat pipe 15 is arranged, as a support element for the printed circuit boards 11, 13, in particular for the first printed circuit board 11, relatively centrally between the first printed circuit board 11 and the aluminum base element 16, with the result that heat from the first printed circuit board 11 may be carried away directly toward the outside via the aluminum base element. For this purpose, the heat pipe 15 is arranged in a thermally contact-forming fashion on the first printed circuit board 11 and the aluminum base element 16. Furthermore, the heat pipe 15 is also thermally connected to the second printed circuit board 13, in order also to be able to cool the driver electronics system 14. Furthermore, the LED module 10 may even if not illustrated here, include yet further heat pipes which also extend vertically and are thermally connected to the printed circuit boards 11, 13 and to the aluminum base element 16.

FIG. 2A shows a schematic illustration of an LED module 10 with a heat pipe arrangement 18 with a centrally arranged heat pipe 15 and a base element 19 and a cover element 20 according to an embodiment of the present disclosure. The first printed circuit board 11 with the LEDs 12 is arranged here on the cover element 20 in a thermally contact-forming fashion, and the base element is arranged on the aluminum base element 16 of the LED module 10 in a thermally contact-forming fashion. Furthermore, the second printed circuit board 13 on which the driver electronics system 14 is arranged may also be thermally connected to the central heat pipe 15. Furthermore, the heat pipe arrangement 18 is, as in all the exemplary embodiments, simultaneously embodied as a support element of the first printed circuit board 11 and of the second printed circuit board 13. As a result of the spatially extended structure of the base element 19 and of the cover element 20, even better conduction away of heat is therefore achieved since the heat may be input into the heat pipe and extracted again over an even larger surface.

FIG. 2B shows a schematic illustration of a plan view of a base element 19 and/or a cover element 20 with spiral-shaped heat pipes 15 of a heat pipe arrangement 18 of an LED module 10 according to an exemplary embodiment of the present disclosure. Optimum conduction of heat may also be achieved by virtue of the spiral-shaped embodiment of the heat pipes 15, since the spatially extended structure permits better inputting and extraction of heat. The heat pipes 15 are embodied here in one piece, in particular the base element 19, the cover element 20 and the central heat pipe 15 which connects the base element 19 and the cover element 20 are embodied in one piece.

FIG. 3A shows a schematic illustration of an LED module 10 with a heat pipe arrangement 18 as in FIG. 2A, just with a laterally arranged heat pipe 15 instead of the central one, according to an embodiment of the present disclosure. This arrangement possibility may also include yet further heat pipes 15, such as, for example, further lateral or centrally arranged heat pipes 15. In this embodiment, the base element 19 of the heat pipe arrangement 18 and/or cover element 20 may be embodied as illustrated in FIG. 3B.

FIG. 3B shows a schematic illustration of a plan view of a further configuration possibility of the base element 19 and/or of the cover element 20 of a heat pipe arrangement 18 of an LED module 10 according to an embodiment of the present disclosure.

In this context, the base element 19 and/or the cover element 20 may be embodied as planar heat pipes 15. In this context, the base element 19 and cover element 20 are also embodied in one piece with the lateral vertically extending heat pipe 15.

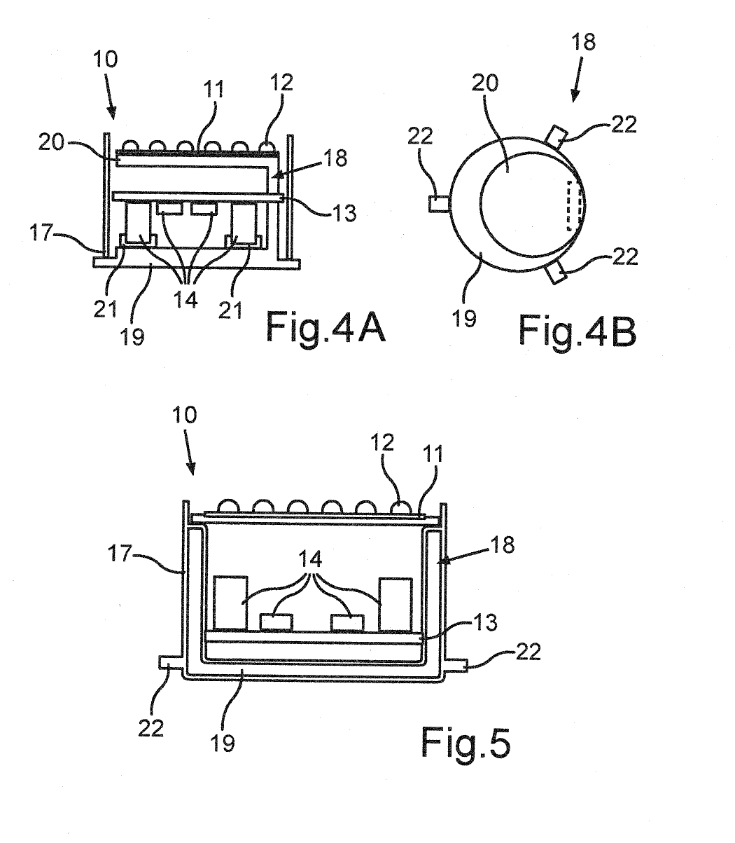

FIG. 4A shows a schematic illustration of an LED module 10 with a heat pipe arrangement 18 as in FIG. 3A. In addition, the LED module has connecting elements 21 via which the individual components of the driver electronics system 14 may be thermally coupled to the heat pipe arrangement 18. In this context, at least the components of the driver electronics system 14 which are to be coupled are preferably arranged on the underside of the second printed circuit board 13. In this way, the components may be thermally coupled directly to the base element 19 of the heat pipe arrangement 18, as a result of which particularly effective cooling of the driver electronics system 14 is brought about. Furthermore, in this case the base element 19 of the heat pipe arrangement 18 is at the same time the boundary of the LED module 10 toward the bottom. The base element 19 and cover element 20 may be embodied here as illustrated in FIG. 4B.

FIG. 4B shows a schematic illustration of a plan view of a heat pipe arrangement with planar heat pipes as base element and cover element. In this example, the heat pipes which are embodied in a planar fashion have a round shape. Furthermore, the base element 19 may also have base mount elements 22 in order to be able to attach the LED module 10 easily in a base mount system.

FIG. 5 shows a schematic illustration of an LED module 10 with a heat pipe arrangement 18 which is integrated into the insulation housing 17. In this context, the outer sheath could consist of plastic, and the inner sheath of metal, preferably copper or aluminum. The heat pipe arrangement 18 could therefore consist of different material compositions in order, on the one hand, to offer a good thermal input surface and, on the other hand, to have an electrically insulating effect. Furthermore, the heat pipe arrangement 18 is embodied as a spatially extended body, such as, in this example in the shape of a beaker, i.e. as a hollow cylinder with a base. In particular, the heat pipe arrangement 18 may be embodied here as a housing and be encased with an insulating material. In this context, the printed circuit boards 11, 13 are also in thermal contact with the heat pipe arrangement. Since the heat pipe arrangement 18 provides substantially better conduction away of heat from the LED module 10 than, for example, an aluminum housing, a significantly more compact arrangement of the LED module 10 is also possible here, without this compact arrangement leading to accumulation of heat in the LED module 10 and as a result to overheating of the LED module 10 and the components thereof.

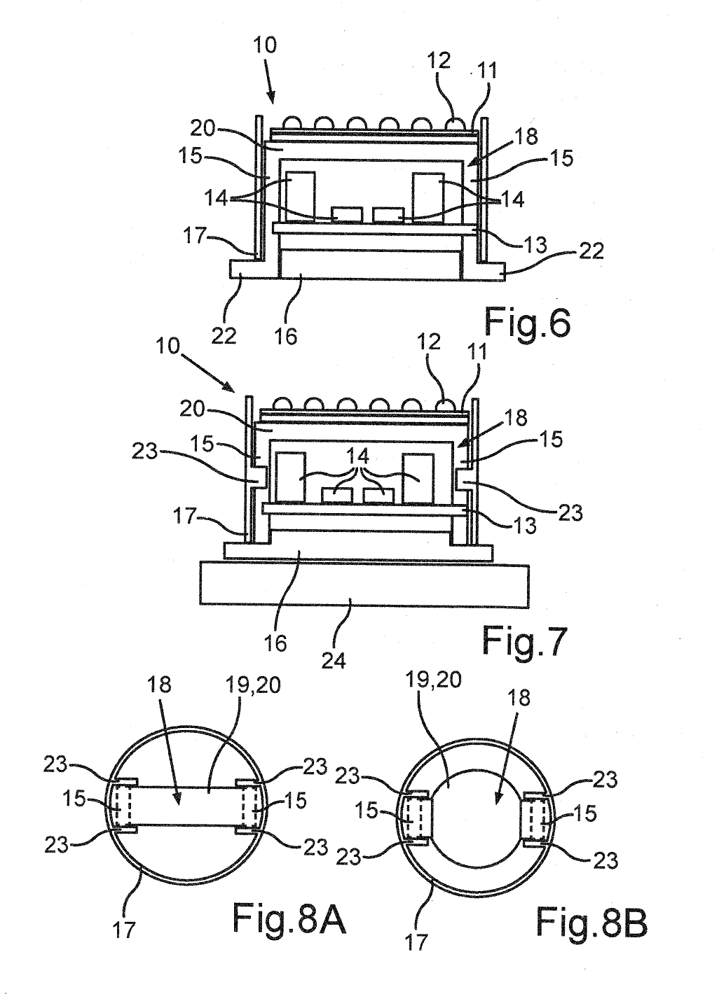

FIG. 6 shows a schematic illustration of an LED module 10 with a heat pipe arrangement 18, a metallic base element 16 and laterally extending heat pipes 15 with base mount elements 22 according to an embodiment of the present disclosure. In this example, the heat pipe arrangement 18 includes just a cover element 20 on which the first printed circuit board 11 with the LEDs 12 is arranged. The base element 16 of the LED module 10 is formed here by a metallic base plate for planar distribution of heat, as a result of which better transmission of heat to a heat sink 24 positioned behind (not illustrated) may be brought about. Furthermore, vertically extending heat pipes 15 are arranged laterally on the cover element 20 and have toward the outside in the region of the base element 16 base mount elements 22 for latching into a base mount system. Said base mount elements 22 may be formed directly by the heat pipes 15.

FIG. 7 shows a schematic illustration of an LED module 10 with a heat pipe arrangement 18 with laterally extending heat pipes 15 and a housing 17 with attachment elements 23 according to an embodiment of the present disclosure. The housing 17 may be attached to the heat pipe arrangement 18, for example by clipping on, by means of these attachment elements 23 which may be embodied in one piece with the electrically insulating housing 17. The heat pipe arrangement 18 may therefore also serve at the same time as a support for the electrically insulating housing 17. Furthermore, in this example a heat sink is also illustrated on which the LED module 10 may be arranged for better conduction away of heat.

FIG. 8A shows a schematic illustration of a plan view of a heat pipe arrangement 18 and a housing 17 which is attached to the heat pipe arrangement 18 by means of attachment elements 23, according to an embodiment of the present disclosure. In this context, a base element 19 and/or cover element 20, of planar design and rectangular in shape, of the heat pipe arrangement are illustrated with heat pipes 15 arranged laterally thereon. The electrically insulating housing 17 with the attachment elements 23 may be clipped onto these lateral heat pipes 15. FIG. 8B shows, like FIG. 8A, a schematic illustration of a plan view of a heat pipe arrangement 18, just with a heat pipe 15 which is round and of planar design as the base element 19 and/or cover element 20.

Furthermore, all the features and configuration possibilities for the individual components of the LED module 10 which are described here, such as, for example, the shaping and structure of the base element 19 and of the cover element 20 as well as the number and arrangement of vertical heat pipes 15, the arrangement of the printed circuit boards 11, 13 as well as components of the driver electronics system 14 arranged on the upper side and/or underside thereof, and the possible thermal connection thereof to the heat pipe arrangement 18 etc., may be combined with one another.

Overall, in this way an LED module is made available which, through the use of a heat pipe arrangement for dissipating heat and at the same time as a support element for the printed circuit boards of the module, provides a significantly higher level of flexibility in the arrangement possibilities of the individual components of the module, and permits considerably more efficient conduction away of heat and a much more compact and space-saving configuration of such an LED module.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An LED module, comprising:
at least one LED,
at least one first printed circuit board, on which the at least one LED is arranged, and
a support element which is designed to support the at least one first printed circuit board, wherein
the support element is embodied as a heat pipe arrangement which comprises at least one heat pipe.

2. The LED module as claimed in claim 1, wherein
the LED module comprises a housing which is formed from an electrically insulating material and which is embodied at least partially as a boundary of the LED module toward the outside.

3. The LED module as claimed in claim 1, wherein
the LED module comprises a base element, wherein the at least one heat pipe is arranged in a thermally contact-forming fashion with one end on the at least one first printed circuit board, and with another end on the base element of the LED module.

4. The LED module as claimed in claim 3, wherein
the LED module comprises at least one second printed circuit board and one driver electronics system arranged on the at least one second printed circuit board for the at least one LED, wherein the at least one second printed circuit board is arranged between the at least one first printed circuit board and the base element of the LED module, wherein by means of the heat pipe there is a thermal connection between the at least one second printed circuit board and the base element, and a thermal connection between the at least one second printed circuit board and the one first printed circuit board.

5. The LED module as claimed in claim 1, wherein
the heat pipe arrangement comprises a base element and a cover element which are embodied in one piece with the at least one heat pipe, and wherein the at least one first printed circuit board is arranged on the cover element.

6. The LED module as claimed in claim 5, wherein
the base element of the heat pipe arrangement is the base element of the LED module or is arranged thereon in a thermally contact-forming fashion.

7. The LED module as claimed in claim 5, wherein
the base element of the heat pipe arrangement and/or the cover element are embodied at least partially as planar heat pipes.

8. The LED module as claimed in claim 5, wherein
the base element of the heat pipe arrangement and/or the cover element are embodied at least partially as spiral-shaped heat pipes.

9. The LED module as claimed in claim 4, wherein
the LED module comprises a connecting element via which at least one electronic component of the driver electronics system is thermally coupled to the heat pipe arrangement, in particular to the base element thereof.

10. The LED module as claimed in claim 4, wherein
the heat pipe arrangement is embodied as a housing of the LED module, wherein the housing has at least one opening, wherein the first printed circuit board is arranged on the at least one opening on the housing in a thermally contact-forming fashion, wherein the at least one second printed circuit board is arranged in the housing, and wherein the housing is encased by an electrically insulating material.

11. The LED module as claimed in claim 2, wherein
the heat pipe arrangement is embodied as a support of the housing of the LED module.

12. The LED module as claimed in claim 2, wherein
the housing of the LED module has attachment elements by means of which the housing is attached to the heat pipe arrangement.

13. The LED module as claimed in claim 1, wherein
the heat pipe arrangement is embodied as a spatially extended structure.

14. The LED module as claimed in claim 5, wherein
the base element of the heat pipe arrangement comprises base mount elements which are designed to attach the LED module to a base mount system.

15. The LED module as claimed in claim 13, wherein the spatially extended structure is a hollow cylinder and/or the form of a right parallelepiped.
